(19) United States
(12) Patent Application Publication
(10) Pub. No.: US 2018/0148567 A1
(43) Pub. Date: May 31, 2018

(54) STYRENE/BUTADIENE RUBBER EXTENDED WITH LOW UNSATURATED SOYBEAN OIL AND TIRE WITH COMPONENT

(71) Applicant: The Goodyear Tire & Rubber Company, Akron, OH (US)

(72) Inventors: George Jim Papakonstantopoulos, Medina, OH (US); Bruce Raymond Hahn, Hudson, OH (US); Stephan Rodewald, Canal Fulton, OH (US)

(21) Appl. No.: 15/361,532

(22) Filed: Nov. 28, 2016

(51) Int. Cl. C08L 9/06

(52) U.S. Cl. CPC C08L 9/06; C08L 2205/06; C08L 2205/02

(57) ABSTRACT

The invention relates to styrene/butadiene elastomer extended with a specialized soybean oil comprised of a low unsaturation containing soybean oil. The specialized soybean oil is a vegetable triglyceride soybean oil containing a high concentration of oleic acid ester and thereby a low unsaturation soybean oil. The invention relates to preparation of styrene/butadiene rubber extended with such specialized soybean oil, a prepared rubber composition and tires with component thereof. Such styrene/butadiene rubber is comprised of an organic solvent solution polymerization prepared styrene/butadiene elastomer.

### FIELD OF THE INVENTION

This invention relates to styrene/butadiene rubber extended with a low unsaturation soybean oil. The soybean oil contains a high content of oleic acid ester and is thereby a low unsaturated soybean oil. The invention relates to preparation of styrene/butadiene rubber extended with such specialized soybean oil, a prepared rubber composition and tires with component thereof. Such styrene/butadiene rubber is comprised of an organic solvent solution polymerization prepared styrene/butadiene elastomer.

### BACKGROUND OF THE INVENTION

Styrene/butadiene copolymer elastomers are sometimes extended with petroleum based rubber processing oils, particularly the elastomers having a high viscosity, namely a high Mooney (ML1+4) (100° C.) viscosity.

The term “extended” is used to describe pre-blending the petroleum based rubber processing oil with a low viscosity cement comprised of styrene/butadiene rubber (SSBR) and organic solvent resulting from polymerization of a combination of styrene and 1,3-butadiene monomers in a solvent solution from which a composite comprised of the styrene/butadiene rubber and petroleum based processing oil is recovered. The composite is blended with various rubber compounding ingredients to prepare a rubber composition.

Such pre-blend, rubber cement-based, rubber extension is particularly valuable for extending high viscosity (high Mooney viscosity) rubbers such as for example a high viscosity SSBR, which would otherwise be difficult to blend with the petroleum processing oil because of their high viscosity.

It is important to appreciate that such low viscosity pre-blend based “extending” of the rubber (e.g. SSBR) is very different from more simply blending the petroleum processing oil with solid rubber in a rubber mixer.

As indicated, to enable reasonable processing of high viscosity SSBR elastomers, such high viscosity SSBR elastomers are sometimes blended with petroleum oil at the SSBR manufacturing facility by mixing the petroleum based oil with the low viscosity solvent cement of the high viscosity SSBR product of polymerizing styrene and 1,3-butadiene monomers before recovery of the high viscosity SSBR elastomer from the cement. Such cement may sometimes referred to as a polymerizate.

The resulting composite of the high viscosity SSBR and petroleum oil is then recovered from the cement. The rubber composite is of a significantly lower viscosity than the high viscosity rubber and is easier to process in rubber processing equipment. The rubber composite may therefore be used to prepare rubber compositions by blending with appropriate ingredients.

Exemplary of such petroleum based rubber processing oils are, for example, aromatic, naphthenic and paraffinic based oils, particularly their mixtures.

In one aspect, such pre-blend based extension of elastomers, particularly high viscosity elastomers, has been taught and/or practiced with vegetable triglyceride oils such as soybean oil.

Soybean oil is a vegetable triglyceride oil comprised of mixed saturated, mono-unsaturated and polyunsaturated triglyceride esters of fatty acids.

Conventional soybean oil is understood to be comprised of mixed saturated, mono-unsaturated and polyunsaturated triglyceride esters of fatty acids. The unsaturated ester content of the soybean oil is understood to be conventionally comprised of a minimal mono-unsaturated triglyceride ester content in a form of oleic acid based ester (e.g. about 20 to about 35 percent of the unsaturated fatty acid ester components of the soybean oil), and therefore a major content of unsaturated esters of the soybean oil being comprised of about 70 to about 80 percent poly-unsaturated esters containing primarily di-functional linoleic acid ester and tri-functional linolenic acid ester.

It is desired to evaluate soybean oil extension of SSBR with a specialized soybean oil containing a significantly increased mono-unsaturated oleic acid ester component of the triglyceride based soybean oil and thereby a significantly reduced unsaturation content of the soybean oil. Such specialized soybean oil is to be obtained as a natural vegetable oil obtained from a hybrid soybean plant.

In one embodiment, at least about 65, alternately about 75 to about 95, percent of the unsaturated fatty acid esters of the specialized soybean oil is comprised of mono-unsaturated oleic acid ester (wherein the combination of saturated and unsaturated fatty acids is comprised of about 65 to about 90 percent of the mono-unsaturated oleic acid ester) and with the remainder of the unsaturated fatty acid esters being comprised of poly-unsaturated fatty acid esters.

For such evaluation, it is important to appreciate that the triglyceride ester based specialized soybean oil is chemically differentiated from petroleum (hydrocarbon) based oils, in a sense that such specialized soybean oil contains a significant degree of mono-unsaturation (from oleic acid ester) and is clearly not a linear or an aromatic petroleum based oil.

Therefore, the triglyceride based specialized soybean oil contains a very high content of mono-unsaturated oleic fatty acid ester component of the triglyceride esters and a minor content of di-unsaturated linoleic acid ester and tri-unsaturated linolenic acid ester component of the triglyceride. Further, it is considered that such high mono-unsaturation content of the fatty acid ester component of the triglyceride ester based specialized soybean oil is not present in a more conventional soybean oil.

The challenge of extending the SSBR elastomer with the specialized soybean oil in contrast to more conventional soybean oil to prepare a composite thereof and to thereafter prepare a rubber composition containing such composite is to be evaluated with results being unknown until such evaluation is undertaken.

In practice, the chemical composition of soybean oil may be determined, for example, by gas chromatographic (GC) analysis according to ASTM D5974. For the gas chromatographic analysis (GC analysis), the triglycerides of the soybean oil are converted into fatty acid methyl esters by reflux in an acidic methanol-toluene azeotrope before the GC analysis. Gas chromatographic analysis of the fatty acid methyl esters can show the high degree of mono-unsaturation of the triglyceride ester based specialized soybean oil.

Historically, a vegetable oil such as for example soybean oil, or soy oil, has been used for mixing with various rubber compositions by free oil addition to the rubber composition rather than soy oil extension of the elastomer at its point of manufacture. For example, and not intended to be limiting, see U.S. Pat. Nos. 7,919,553, 8,100,157 and 8,022,136.

However, as indicated, it is desired to evaluate use of the specialized soybean oil for extending organic solvent solution polymerization prepared styrene/butadiene copolymer elastomers (SSBR), particularly a high viscosity SSBR.

In the description of this invention, the terms “compounded” rubber compositions and “compounds”; where used refer to rubber compositions which have been compounded, or blended, with appropriate rubber compounding ingredients. The terms “rubber” and “elastomer” may be used interchangeably unless otherwise indicated. The amounts of materials are usually expressed in parts of material per 100 parts of rubber by weight (phr).

### SUMMARY AND PRACTICE OF THE INVENTION

The invention is directed to extending a styrene/butadiene elastomer (SSBR) with a specialized triglyceride soybean vegetable oil in its solvent-containing polymerization cement, and thereby before recovery of the SSBR from its cement. The cement is the product of polymerization of styrene and 1,3-butadiene monomers in a solvent solution.

The method involves preparing a soybean oil extended styrene/butadiene rubber (SSBR) comprised of blending a specialized soybean triglyceride oil with a cement comprised of organic solvent and styrene/butadiene rubber and recovering a composite from said cement comprised of said specialized soybean oil and SSBR, where the soybean oil is comprised of saturated and unsaturated fatty acid esters and where said unsaturated fatty acid esters are comprised of at least 65 percent, alternately about 75 to about 95 percent, of mono unsaturated oleic acid ester with the remainder of the unsaturated esters are comprised of poly-unsaturated acid esters comprised primarily of linoleic acid ester and linolenic acid ester.

In accordance with this invention, a method of preparing a triglyceride vegetable oil extended organic solution polymerization prepared styrene/butadiene elastomer comprising, based on parts by weight per 100 parts by weight of elastomer (phr):

(A) anionically initiating polymerization of monomers comprised of styrene and 1,3-butadiene in an organic solvent solution to form a synthetic styrene/butadiene elastomer (SSBR) contained in a cement comprised of said SSBR and solvent;

(B) terminating said polymerization of said monomers in said cement;

(C) blending from about 5 to about 60, alternately from about 10 to about 40, phr of specialized soybean oil with said cement, and

(D) recovering said SSBR as a composite comprised of said SSBR and said triglyceride vegetable oil;

wherein said specialized soybean oil is a vegetable triglyceride oil comprised of mixed saturated, mono-unsaturated and poly-unsaturated triglyceride esters of fatty acids having its unsaturated fatty acid ester content comprised of at least about 65 percent, alternately about 75 to about 95 percent, of mono-unsaturated oleic acid with the remainder of the unsaturated esters comprised of poly-unsaturated acid esters containing primarily di-unsaturated linoleic acid ester and tri-unsaturated linolenic acid ester.

In one embodiment, said high oleic acid based ester content specialized soybean oil contains a minimum of about 1 percent, and generally in a range of form about 1.5 to about 5 percent of tri-unsaturated linolenic acid ester.

In one embodiment, said specialized soybean oil is exclusive of plasticized starch containing soybean oil.

In further accordance with this invention, a composite of a specialized soybean oil extended SSBR is provided.

In one embodiment, such SSBR is provided as a tin or silicon coupled SSBR.

In one embodiment, such SSBR is provided as functionalized SSBR containing at least one functional group reactive with hydroxyl groups on a precipitated silica (e.g. at least one of amine, siloxy, thiol and carboxyl groups).

In further accordance with this invention, a rubber composition containing a specialized soybean oil extended SSBR is provided.

In further accordance with this invention, a rubber composition containing said specialized soybean oil extended SSBR is provided which further contains an additive to the rubber composition comprised of at least one of triglyceride vegetable oil and petroleum based oil (in addition to the specialized soybean oil contained in the specialized soybean oil extended SSBR). Such additional triglyceride oil and/or petroleum based oil is therefore added to the rubber composition itself. Representative of such additional vegetable triglyceride oils may be comprised of, for example, at least one of soybean oil, sunflower oil, corn oil, rapeseed oil, canola oil and additional soybean oil where said additional soybean oil has an oleic acid ester content of, for example, in a range of from about 15 to about 30 percent.

In one embodiment, it is understood that the specialized soybean oil is not inclusive of, and is different from, other vegetable triglyceride oils, even vegetable triglyceride oils which might have a high mono-unsaturated oleic acid ester content because of other inconsistences which they may have relative to the specialized soybean oil.

In additional accordance with this invention, an article of manufacture, such as for example a tire, is provided having a component comprised of such rubber composition.

In practice, anionic polymerizations employed in making such SSBR in the organic solvent solution are typically initiated by adding an organolithium initiator to an organic solution polymerization medium which contains the styrene and 1,3-butadiene monomers. Such polymerizations are typically carried out utilizing continuous or batch polymerization techniques. In such continuous polymerizations, monomers and initiator are continuously added to the organic solvent polymerization medium with the synthesized rubbery styrene/butadiene elastomer (SSBR) being continuously withdrawn in its organic solvent solution as a cement thereof. Such continuous polymerizations are typically conducted in a multiple reactor system.

Suitable polymerization methods are known in the art, for example, and without an intended limitation, as disclosed in one or more U.S. Pat. Nos. 4,843,120; 5,137,998; 5,047,483; 5,272,220; 5,239,009; 5,061,765; 5,405,927; 5,654,384; 5,620,939; 5,627,237; 5,677,402; 6,103,842; and 6,559,240; all of which are fully incorporated herein by reference.

Such anionic initiated polymerization typically involves use of an organo alkali metal compound, usually an organo monolithium compound, as an initiator. The first step of the process usually involves contacting the combination of styrene and 1,3-butadiene monomer(s) to be polymerized with the organo monolithium compound (initiator) in the presence of an inert diluent, or solvent, thereby forming a living polymer compound having the simplified structure A-Li. The monomers may be a vinyl aromatic hydrocarbon such as the styrene and a conjugated diene such as the 1,3-butadiene. Styrene is the preferred vinyl aromatic hydrocarbon and the preferred diene is 1,3-butadiene.

The inert diluent, or solvent, may be an aromatic or naphthenic hydrocarbon, e.g., benzene or cyclohexane, which may be modified by the presence of an alkene or alkane such as pentenes or pentanes. Specific examples of other suitable diluents may include n-pentane, hexane such as for example n-hexane, isoctane, cyclohexane, toluene, benzene, xylene and the like. The organomonolithium compounds (initiators) that are reacted with the polymerizable additive in this invention are represented by the formula a RLi, wherein R is an aliphatic, cycloaliphatic, or aromatic radical, or combinations thereof, preferably containing from 2 to 20 carbon atoms per molecule. Exemplary of these organomonolithium compounds are ethyllithium, n-propyllithium, isopropyllithium, n-butyllithium, sec-butyllithium, tertoctyllithium, n-decyllithium, n-eicosyllithium, phenyllithium, 2-naphthyllithium, 4-butylphenyllithium, 4-tolyllithium, 4-phenylbutyllithium, cyclohexyllithium, 3,5-di-n-heptylcyclohexyllithium, 4-cyclopentylbutyl-lithium, and the like. The alkyllithium compounds are preferred for employment according to this invention, especially those wherein the alkyl group contains from 3 to 10 carbon atoms. A much preferred initiator is n-butyllithium.

The amount of organolithium initiator to effect the anionically initiated polymerization will vary with the monomer(s) being polymerized and with the molecular weight that is desired for the polymer being synthesized. However, generally, from 0.01 to 1 phm (parts per 100 parts by weight of monomer) of an organolithium initiator will be often be utilized. In many cases, from 0.01 to 0.1 phm of an organolithium initiator will be utilized with it often being more desirable to utilize 0.025 to 0.07 phm of the organolithium initiator.

The polymerization temperature utilized can vary over a broad range such as, for example, from about −20° C. to about 180° C. However, often a polymerization temperature within a range of about 30° C. to about 125° C. will be desired. It is often typically desired for the polymerization temperature to be within a more narrow range of about 45° C. to about 100° C. or within a range of from about 60° C. to about 85° C. The pressure used for the polymerization reaction, where applicable, will normally be sufficient to maintain a substantially liquid phase under the conditions of the polymerization reaction.

The SSBRs prepared in the organic solution by the anionically initiated polymerization may be tin or silicon coupled with a suitable coupling agent, such as, for example, a tin halide or a silicon halide, to improve desired physical properties by increasing their molecular weight with a usual increase in their viscosity (e.g. Mooney viscosity of the uncured SSBR). Tin-coupled styrene/butadiene polymers have been observed to improve tire treadwear and to reduce tire rolling resistance when used in tire tread rubbers. Such tin-coupled SSBRs are typically made by coupling the SSBR with a tin coupling agent at or near the end of the polymerization used in synthesizing the SSBR. In the coupling process, live polymer chain ends react with the tin coupling agent, thereby coupling the SSBR. For example, up to four live chain ends can react with tin tetrahalides, such as tin tetrachloride, thereby coupling the polymer chains together.

The coupling efficiency of the tin coupling agent is dependent on many factors, such as the quantity of live chain ends available for coupling and the quantity and type of polar modifier, if any, employed in the polymerization. For instance, tin coupling agents are generally not as effective in the presence of polar modifiers. However, polar modifiers such as tetramethylethylenediamine, are frequently used to increase the glass transition temperature of the rubber for improved properties, such as improved traction characteristics in tire tread compounds. Coupling reactions that are carried out in the presence of polar modifiers typically have a coupling efficiency of about 50 to 60 percent in batch processes.

In cases where the SSBR will be used in rubber compositions that are loaded primarily with carbon black reinforcement, the coupling agent for preparing the elastomer may be a tin halide. The tin halide will normally be a tin tetrahalide, such as tin tetrachloride, tin tetrabromide, tin tetrafluoride or tin tetraiodide. However, mono-alkyl tin trihalides can also optionally be used. Polymers coupled with mono-alkyl tin trihalides have a maximum of three arms. This is, of course, in contrast to SSBRs coupled with tin tetrahalides which have a maximum of four arms. To induce a higher level of branching, tin tetrahalides are normally preferred. As a general rule, tin tetrachloride is usually the most preferred.

In cases where the SSBR will be used in compounds that are loaded with high levels of silica, the coupling agent for preparing the SSBR may be a silicon halide. The silicon-coupling agents that can be used will normally be silicon tetrahalides, such as silicon tetrachloride, silicon tetrabromide, silicon tetrafluoride or silicon tetraiodide. However, mono-alkyl silicon trihalides can also optionally be used. SSBRs coupled with silicon trihalides have a maximum of three arms. This is, of course, in contrast to SSBRs coupled with silicon tetrahalides during their manufacture which have a maximum of four arms. To induce a higher level of branching, if desired, of the SSBR during its manufacture, silicon tetrahalides are normally preferred. In general, silicon tetrachloride is usually the most desirable of the silicon-coupling agents for such purpose.

In one embodiment, various organic solvents may be used for the polymerization medium which are relatively inert to the polymerization reaction such as for example, the aforesaid n-pentane, n-hexane, isooctane, cyclohexane, toluene, benzene, xylene and the like, (exclusive, of course, of water based emulsifier containing liquid mediums). Solvent removal from the polymerizate, or cement, may be accomplished using one or more of the methods as are known in the art, including but not limited to precipitation, steam stripping, filtration, centrifugation, drying and the like.

The recovered composite of specialized soybean oil extended SSBR may be compounded (blended) into a vulcanizable (sulfur vulcanizable) rubber composition which may, and will usually, include other elastomers, particularly sulfur curable diene-based elastomers, as is well known to those familiar with such art. The phrase “sulfur curable rubber” or elastomer such as “diene-based elastomers” is intended to include both natural rubber and its various raw and reclaim forms as well as various synthetic rubbers including the SSBR used in the practice of this invention.

In further accordance with this invention, a rubber composition is provided comprised of said specialized soybean oil extended SSBR.

In additional accordance with this invention, a rubber composition is provided comprised of, based upon parts by weight per 100 parts by weight rubber (phr):

(A) conjugated diene-based elastomers comprised of:
(1) about 50 to about 100, alternately from about 50 to about 80, phr of SSBR which is specialized soybean oil extended (the SSBR component of the specialized soybean oil extended SSBR according to this invention), and correspondingly,
(2) from about zero to about 50, alternately from about 20 to about 50, phr of at least one additional elastomer comprised of at least one of polymers of at least one of isoprene and 1,3-butadiene and copolymers of styrene and at least one of isoprene and 1,3-butadiene (in addition to and therefore other than said triglyceride oil extended SSBR);

(B) about 40 to about 110, alternately from about 50 to about 80, phr of reinforcing filler comprised of:
(1) amorphous synthetic silica (e.g. precipitated silica), or
(2) rubber reinforcing carbon black, or
(3) combination of precipitated silica and rubber reinforcing carbon black (containing, for example, about 20 to about 99 weight percent of precipitated silica, alternately from about 55 to about 90 weight percent precipitated silica for silica-rich reinforcing filler and alternately from about 20 to about 45 weight percent precipitated silica for a carbon black-rich reinforcing filler);

(C) silica coupling agent (for said precipitated silica where said reinforcing filler contains precipitated silica) having a moiety reactive with hydroxyl groups (e.g. silanol groups) on said precipitated silica and another different moiety interactive with carbon-to-carbon double bonds of said conjugated diene-based elastomers (including said SSBR).

In further accordance with this invention a tire is provided which contains at least one component comprised of said rubber composition.

Representative examples of said additional rubbers, or elastomers, are, for example, cis 1,4-polyisoprene, cis 1,4-polybutadiene, isoprene/butadiene, styrene/isoprene, styrene/butadiene and styrene/isoprene/butadiene elastomers. Additional examples of elastomers which may be used include 3,4-polyisoprene rubber, carboxylated rubber, silicon-coupled and tin-coupled star-branched elastomers. Often desired rubber or elastomers are cis 1,4-polybutadiene, styrene/butadiene rubber and cis 1,4-polyisorprene rubber.

Such precipitated silicas may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Such precipitated silicas may, for example, also be characterized by having a dibutylphthalate (DBP) absorption value, for example, in a range of about 100 to about 400, and more usually about 150 to about 300 cc/100 g.

Various commercially available precipitated silicas may be used, such as, only for example herein, and without limitation, silicas from PPG Industries under the Hi-Sil trademark with designations 210, 243, etc.; silicas from Rhodia, with, for example, designations of Z1165MP and Z165GR, silicas from Evonic with, for example, designations VN2 and VN3 and chemically treated (pre-hydrophobated) precipitated silicas such as for example Agilon™ 400 from PPG.

Representative examples of rubber reinforcing carbon blacks are, for example, and not intended to be limiting, those with ASTM designations of N110, N121, N220, N231, N234, N242, N293, N299, 5315, N326, N330, N332, N339, N343, N347, N351, N358, N375, N539, N550, N582, N630, N642, N650, N683, N754, N762, N765, N774, N787, N907, N908, N990 and N991. Such rubber reinforcing carbon blacks may have iodine absorptions ranging from, for example, 9 to 145 g/kg and DBP numbers ranging from 34 to 150 cc/100 g.

Other fillers may be used in the vulcanizable rubber composition including, but not limited to, particulate fillers including ultra high molecular weight polyethylene (UHMWPE); particulate polymer gels such as those disclosed in U.S. Pat. Nos. 6,242,534; 6,207,757; 6,133,364; 6,372,857; 5,395,891; or 6,127,488, and plasticized starch composite filler such as that disclosed in U.S. Pat. No. 5,672,639. One or more other fillers may be used in an amount ranging from about 1 to about 20 phr.

It may be desired for the precipitated silica-containing rubber composition to contain a silica coupling agent for the silica comprised of, for example,

(A) bis(3-trialkoxysilylalkyl) polysulfide containing an average in range of from about 2 to about 4 sulfur atoms in its connecting bridge, or

(B) an organoalkoxymercaptosilane, or

(C) their combination.

Representative of such bis(3-trialkoxysilylalkyl) polysulfide is comprised of bis(3-triethoxysilylpropyl) polysulfide.

It is readily understood by those having skill in the art that the vulcanizable rubber composition would be compounded by methods generally known in the rubber compounding art, such as, for example, mixing various additional sulfur-vulcanizable elastomers with said SSBR composite and various commonly used additive materials such as, for example, sulfur and sulfur donor curatives, sulfur vulcanization curing aids, such as activators and retarders and processing additives, resins including tackifying resins and plasticizers, petroleum based or derived process oils as well as triglycerides in addition to said triglyceride extended SSBR, fillers such as rubber reinforcing fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.5 to 6 phr being often preferred. Typical amounts of tackifier resins, if used, may comprise, for example, about 0.5 to about 10 phr, usually about 1 to about 5 phr. Typical amounts of processing aids comprise about 1 to about 50 phr. Additional process oils, if desired, may be added during compounding in the vulcanizable rubber composition in addition to the extending specialized soybean oil contained in the specialized soybean oil extended SSBR. The additional petroleum based or derived oils may include, for example, aromatic, paraffinic, naphthenic, and low PCA oils such as MEW, TDAE, and heavy naphthenic, although low PCA oils might be preferred. Typical amounts of antioxidants may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr. Typical amounts of fatty acids, if used, which can include stearic acid comprise about 0.5 to about 3 phr. Typical amounts of zinc oxide may comprise, for example, about 2 to about 5 phr. Typical amounts of waxes comprise about 1 to about 5 phr. Often microcrystalline waxes are used. Typical amounts of peptizers, when used, may be used in amounts of, for example, about 0.1 to about 1 phr. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 1.5, phr. In another embodiment, combinations of a primary and a secondary accelerator might be used with the secondary accelerator being used in smaller amounts, such as, for example, from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Often desirably the primary accelerator is a sulfenamide. If a second accelerator is used, the secondary accelerator is often desirably a guanidine such as for example a diphenylguanidine, a dithiocarbamate or a thiuram compound.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The vulcanizable rubber composition containing the triglyceride oil extended SSBR may be incorporated in a variety of rubber components of an article of manufacture such as, for example, a tire. For example, the rubber component for the tire may be a tread (including one or more of a tread cap and tread base), sidewall, apex, chafer, sidewall insert, wire coat or innerliner.

Vulcanization of the pneumatic tire of the present invention is generally carried out at conventional temperatures in a range of, for example, from about 140° C. to 200° C. Often it is desired that the vulcanization is conducted at temperatures ranging from about 150° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following examples are presented for the purposes of illustrating and not limiting the present invention. All parts and percentages are parts by weight, usually parts by weight per 100 parts by weight rubber (phr) unless otherwise indicated.

### EXAMPLE I

In this example, the effect of extending an organic solution anionic polymerized styrene and 1,3-butadiene monomers (SSBR) with a vegetable triglyceride soybean oil as a specialized soybean oil having a high mono-unsaturated oleic acid ester component is evaluated and compared to a more conventional soybean oil containing a significantly lower oleic acid ester component content.

Experiments were conducted to evaluate the effect of employing the specialized soybean oil for extension of an SSBR. By the term “extension” or “extended” it is meant that the soybean oil is added to and mixed with a low viscosity polymerization solvent cement of the soybean oil following which composite of the SSBR elastomer and soybean oil is recovered from the cement. The composite is then blended with rubber compounding ingredients to prepare the rubber composition. It is in contrast to simply mixing the SSBR and the soybean oil with rubber compounding ingredients in a rubber mixer to prepare the rubber composition.

Control rubber Sample A contained the SSBR extended by a more conventional soybean oil. (soybean oil pre-blended with the SSBR cement to form a composite thereof).

Experimental rubber Sample B contained the SSBR extended by the specialized soybean oil. (soybean oil pre-blended with the SSBR cement to form a composite thereof).

The rubber Samples were prepared by mixing the elastomers with reinforcing filler as rubber reinforcing carbon black without precipitated silica together in a first non-productive mixing stage (NP1) in an internal rubber mixer for about 4 minutes to a temperature of about 160° C. The resulting mixture was subsequently mixed in a second sequential non-productive mixing stage (NP2) in an internal rubber mixer to a temperature of about 160° C. with no additional ingredients added. The rubber composition was subsequently mixed in a productive mixing stage (P) in an internal rubber mixer with a sulfur cure package, namely sulfur and sulfur cure accelerator(s), for about 2 minutes to a temperature of about 115° C. The rubber composition is removed from its internal mixer after each mixing step and cooled to below 40° C. between each individual non-productive mixing stage and before the final productive mixing stage.

The basic formulation for the Control rubber Sample A using conventional soybean oil extended SSBR and Experimental rubber Sample B using specialized soybean oil extended SSBR. is presented in the following Table 1 expressed in parts by weight per 100 parts of rubber (phr) unless otherwise indicated.

TABLE 1

| | Parts by weight (phr) |
|---|---|
| Non-Productive Mixing Stage (NP) | |
| Conventional soybean oil extended | 110 or 0 (80 SSBR, |
| SSBR¹ | 30 soybean oil)* |
| Specialized soybean oil extended | 110 or 0 (80 SSBR, |
| SSBR² | 30 soybean oil)** |
| Cis 1,4-polybutadiene elastomer³ | 20 |
| Carbon black⁴ | 85 |
| Wax, microcrystalline | 1.5 |
| Zinc oxide | 2 |
| Fatty acid⁵ | 3 |
| Antioxidant | 2 |
| Productive Mixing Stage (P) | |
| Sulfur | 1.4 |
| Sulfur cure accelerator(s)⁶ | 2.4 |
| Antioxidant | 0.7 |

*80 parts by weight SSBR, 30 parts by weight conventional soybean oil extension
**80 parts by weight SSBR, 30 parts by weight specialized soybean oil extension
¹Composite of solution polymerization prepared styrene/butadiene rubber (SSBR) having a Tg of about −18° C., 30 percent bound styrene, 41 percent vinyl content for its butadiene portion and for this Example, extended with (thereby containing) 37.5 parts conventional soybean oil per 100 parts SSBR. The conventional soybean oil was a soybean plant-derived triglyceride oil from Cargill Dressings comprised of saturated and unsaturated fatty acid esters with a minor portion of its unsaturated fatty acid esters being mono-unsaturated oleic fatty acid ester comprised of about 32 percent oleic acid ester, about 68 percent poly-unsaturated fatty acid esters such as for example linoleic acid ester and linolenic acid ester. The saturated fatty acid esters may be, for example palmitic and stearic acid esters.
²Composite of solution polymerization prepared styrene/butadiene rubber (SSBR) having a Tg of about −18° C., about 30 percent bound styrene, 41 percent vinyl content for its butadiene portion and, for this Example, extended with (thereby containing) 37.5 parts specialized soybean oil per 100 parts SSBR. The specialized soybean oil was a soybean oil obtained as Plenish ™ soybean oil from DuPont as a blend of saturated and unsaturated fatty acid esters with the unsaturated fatty acid esters having a mono-unsaturation oleic acid ester content of about 89 percent, a di-unsaturation linoleic acid ester content of about 8 percent and a tri-unsaturation linolenic acid ester content of about 3 percent.
³Cis 1,4-polybutadiene rubber as BUD1207 ™ from The Goodyear Tire & Rubber Company
⁴N330 rubber reinforcing carbon black, ASTM identification
⁵Primarily comprised of stearic, palmitic and oleic acids
⁶Sulfenamide and diphenylguanidine accelerators

The following Table 2 illustrates cure behavior and various physical properties of rubber compositions based upon the basic recipe of Table 1 and reported herein as a Control rubber Sample A and Experimental rubber Sample B. Where cured rubber samples are examined, such as for the stress-strain, hot rebound and hardness values, the rubber samples were cured for about 14 minutes at a temperature of about 160° C.

TABLE 2

| | Samples | |
|---|---|---|
| | Control A | Experimental B |
| Materials (phr) | | |
| Conventional soybean oil extended SSBR | 110 (80 | 0 |
| | SSBR) | |
| Specialized soybean oil extended SSBR | 0 | 110 (80 |
| | | SSBR) |
| Cis 1,4-polybutadiene rubber | 20 | 20 |
| Properties | | |
| RPA¹ (100° C.), Storage Modulus G′, | | |
| MPa Predictive Rubber Processing | | |
| Uncured storage modulus G′, 15% strain, | 273 | 277 |
| 0.83 Hertz (kPa) | | |
| Stiffness (greater is better for predictive | | |
| tread rubber performance) (11 Hertz (kPa) | | |
| Cured storage modulus G′, 1% strain | 2590 | 2735 |
| Cured storage modulus G′, 10% strain | 1286 | 1378 |
| Cured storage modulus G′, 15% strain | 1140 | 1224 |
| Hysteresis Indication (lower is better for | | |
| predictive hysteresis reduction) | | |
| Tan delta at 1% strain | 0.23 | 0.21 |
| Tan delta at 10% strain | 0.24 | 0.23 |
| Tan delta at 15% strain | 0.23 | 0.22 |
| Rebound value of cured rubber, (%), 23° C. | 30 | 31 |
| Rebound value of cured rubber, (%), 100° C. | 54 | 57 |

(higher rebound value is better for predictive hysteresis reduction)
¹Rubber Process Analyzer (RPA) instrument

In Table 2 it is seen that Experimental rubber Sample B containing the composite of SSBR extended with specialized soybean oil contain a high oleic acid ester component content (70 percent) thereby being of a significantly low unsaturation, yielded a rubber composition of a stiffness value (cured rubber storage modulus G′ value) of, for example at a 15 percent strain, 1224 kPa, which was a beneficial increase of the stiffness value (modulus G′) compared to a value of 1140 kPa for the Control rubber composition A containing the composite of SSBR extended with the more conventional soybean oil containing a low oleic acid ester component content, thereby being a significantly higher unsaturation soybean oil.

In Table 2 it is also seen that Experimental rubber Sample B containing the low unsaturation specialized soybean oil yielded a rubber composition having a tan delta value of, for example, at a 15 percent strain, 0.22 which was beneficial reduction from a value of 0.23 for the Control rubber composition A containing significantly higher unsaturation conventional soybean oil. Therefore, the rubber composition of Experimental rubber Sample B was of a beneficially lower predictive hysteresis than the rubber composition of Control rubber Sample A which, in turn, was of a beneficially lower predictive internal heat generation for the rubber composition (Experimental rubber Sample B) during its dynamic use (service) and predictive of a beneficially lower rolling resistance (increased energy savings) for a tire with tread of such rubber composition.

It is concluded that, although the mechanism might not be fully understood, a significant and beneficial discovery was made for soybean oil extension of the SSBR with a specialized soybean oil of a high oleic acid ester content (89 percent of its unsaturated fatty acid content) compared to a more conventional soybean oil having a significantly lower (about 30 percent) oleic acid ester content of its unsaturated fatty acid ester. Such discovery may be a result of the high oleic acid ester content of the unsaturated ester portion of the specialized soybean oil and/or of the correspondingly lower unsaturation content of unsaturated ester portion of the specialized soybean oil.

While certain representative embodiments and details have been shown for the purpose of illustrating the subject invention, it will be apparent to those skilled in this art that various changes and modifications can be made therein without departing from the scope of the subject invention.

What is claimed is:

1. A method of preparing an oil extended styrene/butadiene rubber (SSBR) comprised of blending a specialized soybean triglyceride oil with a cement comprised of organic solvent and styrene/butadiene rubber and recovering a composite from said cement comprised of said specialized soybean oil and SSBR, wherein said specialized soybean oil is comprised of mixed saturated and unsaturated fatty acid esters wherein the unsaturated ester portion of said specialized soybean oil is comprised of at least 65 percent of oleic acid ester.

2. The method of claim 1 for preparing a triglyceride vegetable oil extended organic solution polymerization prepared styrene/butadiene elastomer which comprises, based on parts by weight per 100 parts by weight of elastomer (phr):
(A) anionically initiating polymerization of monomers comprised of styrene and 1,3-butadiene in an organic solvent solution to form a synthetic styrene/butadiene elastomer (SSBR) contained in a cement comprised of said SSBR and said solvent;
(B) terminating said polymerization of said monomers in said cement;
(C) blending from about 5 to about 60 phr of specialized soybean oil with said cement, and
(D) recovering said SSBR as a composite comprised of said SSBR and said specialized soybean oil,
wherein said specialized soybean oil is a vegetable triglyceride oil comprised of mixed mixed saturated, mono-unsaturated and polyunsaturated triglyceride esters of fatty acids having its unsaturated ester content comprised of at least about 65 percent of mono-unsaturated oleic acid.

3. The method of claim 1 wherein said unsaturated ester portion of said specialized soybean oil contains about 75 to about 95 percent mono-unsaturated oleic acid ester component and at least 1 percent linolenic acid ester component.

4. The method of claim 1 wherein said unsaturated ester portion of said specialized soybean oil contains about 75 to about 95 percent mono-unsaturated oleic acid ester and from about 1.5 to about 5 percent linolenic acid ester component.

5. The method of claim 1 wherein said SSBR is a tin or silicon coupled SSBR.

6. The method of claim 1 wherein said SSBR is a functionalized SSBR containing at least one functional group comprised of at least one of amine, siloxy, carboxyl and hydroxyl groups.

7. The method of claim 6 wherein said SSBR is a tin or silicon coupled SSBR.

8. The method of claim 2 wherein said SSBR is the product of an anionic initiated polymerization of styrene and 1,3-butadiene employing n-butyllithium as an initiator in the presence of an inert solvent.

9. A composite of said SSBR extended with specialized soybean oil wherein said specialized soybean oil is a vegetable triglyceride oil comprised of mixed saturated, mono-unsaturated and polyunsaturated triglyceride esters of fatty acids having its unsaturated ester content comprised of at least about 65 percent of mono-unsaturated oleic acid.

10. The rubber composition of claim 9 which contains a styrene/butadiene rubber (SSBR) extended with a specialized soybean oil.

11. The rubber composition of said claim 10 wherein said SSBR is an anionically initiated polymerization product of styrene and 1,3-butadiene monomers.

12. The rubber composition of claim 10 wherein said rubber composition contains at least one additional vegetable triglyceride oil comprised of at least one of sunflower oil, rapeseed oil, corn oil canola oil and additional soybean oil where the unsaturated ester of said additional soybean oil has a mono-unsaturated oleic acid ester content in a range of from about 15 to about 30 percent.

13. A tire having a component comprised of the rubber composition of claim 10.

14. A tire having a component comprised of the rubber composition of claim 11.

15. A tire having a component comprised of the rubber composition of claim 12.

16. A rubber composition comprised of, based upon parts by weight per 100 parts by weight rubber (phr):
(A) conjugated diene-based elastomers comprised of:
(1) about 50 to about 100 phr of specialized soybean oil extended SSBR composite of claim 10, and correspondingly
(2) from about zero to about 50 phr of at least one additional elastomer comprised of at least one of polymers of at least one of isoprene and 1,3-butadiene and copolymers of styrene and at least one of isoprene and 1,3-butadiene;
(B) about 40 to about 110 phr of reinforcing filler comprised of:
(1) amorphous synthetic silica (e.g. precipitated silica), or
(2) rubber reinforcing carbon black, or
(3) combination of precipitated silica and rubber reinforcing carbon black;
(C) silica coupling agent for said precipitated silica where said reinforcing filler contains precipitated silica having a moiety reactive with hydroxyl groups on said precipitated silica and another different moiety interactive with carbon-to-carbon double bonds of said conjugated diene-based elastomers,
wherein said specialized soybean oil is a vegetable triglyceride oil comprised of mixed saturated, mono-unsaturated and polyunsaturated triglyceride esters of fatty acids having its unsaturated ester content comprised of at least about 65 percent of mono-unsaturated oleic acid.

17. A tire having a component of the rubber composition of claim 16 wherein said reinforcing filler is rubber reinforcing carbon black.

18. A tire having a component of the rubber composition of claim 16 where said reinforcing filler is a combination of rubber reinforcing carbon black and precipitated silica containing from about 20 to about 99 weight percent of said precipitated silica.

19. A tire having a component of the rubber composition of claim 16 where said reinforcing filler is a combination of rubber reinforcing carbon black and precipitated silica containing from about 20 to about 45 weight percent of said precipitated silica.

20. The rubber composition which contains a styrene/butadiene rubber (SSBR) extended with a specialized soybean oil of claim 9,
wherein said specialized soybean oil is a vegetable triglyceride oil comprised of mixed saturated, mono-unsaturated and polyunsaturated triglyceride esters of fatty acids having its unsaturated ester content comprised of about 75 to about 95 percent of mono-unsaturated oleic acid and wherein the combination of saturated and unsaturated fatty acids is comprised of about 65 to about 90 percent of the mono-unsaturated oleic acid ester, with the remainder of the unsaturated fatty acid esters being comprised of poly-unsaturated fatty acid esters.
